(19) United States
(12) Patent Application Publication
(10) Pub. No.: US 2016/0191847 A1
(43) Pub. Date: Jun. 30, 2016

(54) METHOD AND APPARATUS FOR REAL TIME STREAMING AND ONBOARD RECORDATION OF VIDEO DATA

(71) Applicant: ABRADO, INC., Houston, TX (US)

(72) Inventors: MARSHAL HARRIS, HOUSTON, TX (US); PHILIP SCHULTZ, KATY, TX (US); CHRISTOPHER MEYERS, YOUNGSVILLE, LA (US); CY BROWN, DUSON, LA (US); JAMES EMORY PALMER, III, LAFAYETTE, LA (US); GAVIN BROWN, LAFAYETTE, LA (US)

(73) Assignee: ABRADO, INC., HOUSTON, TX (US)

(21) Appl. No.: 14/909,499

(22) PCT Filed: Aug. 12, 2014
(86) PCT No.: PCT/US14/50698

§ 371 Date: Feb. 2, 2016

Related U.S. Application Data
(60) Provisional application No. 61/865,171, filed on Aug. 13, 2013.

(51) Int. Cl. H04N 7/01; H04N 7/10; H04N 5/77; H04N 5/232

(52) U.S. Cl. CPC H04N 7/0127; H04N 5/23203; H04N 7/10; H04N 5/23241; H04N 5/77; H04N 2005/2255

(57) ABSTRACT

A method and apparatus for visual inspection of wellbore environments wherein a real-time video feed is received at the earth's surface from a camera assembly positioned downhole within a wellbore. The camera system is capable of recording high quality video images in full streaming quality and speed in either color or black and white bands, simultaneously transmitting live visual images to the earth's surface, and accepting and acting upon commands from the surface (including, without limitation, recording programmability).

### PRIORITY CLAIM AND INCORPORATION BY REFERENCE

This application claims the benefit of, and priority to, U.S. provisional patent application Ser. No. 61/865,171 filed Aug. 13, 2013. The entire disclosure of this provisional application is incorporated herein by reference.

### BACKGROUND OF THE INVENTION

1. Field of the Invention

The present invention pertains to a method and apparatus for recording visual images in remote environments including, without limitation, downhole in a wellbore that penetrates subterranean formations. More particularly, the present invention pertains to a camera assembly for recording high quality video images downhole in a wellbore, while transmitting streaming video to the earth's surface.

2. Brief Description of the Prior Art

Camera systems exist for use in confined areas such as, for example, within wells and wellbores that penetrate subterranean formations. Generally, said camera systems obtain visual images in the form of still photographs or videos. Such visual images are often beneficial for purposes of diagnosing downhole wellbore problems and/or evaluating the effectiveness of operations conducted within said wellbores.

Specialty fiber optic cables are also used to deploy fiber optic cameras which are capable of full-motion streaming transmission to the surface. However, these types of cables are more costly, generally fragile, and not typically found on a job site or readily available.

Most commonly used today, non-fiber optic enabled camera systems are lowered within a wellbore, deployed to a desired location within said wellbore, and thereafter retrieved from said wellbore. Although jointed or continuous pipe or other tubular goods can be used to convey such camera systems in and out of wellbores, it is typically more operationally efficient and cost-effective to utilize flexible wireline or cable to convey such camera systems in such wellbores. Additionally, wireline OR mono-conductor electric line cable is commonly found on work sites, thereby resulting in no special logistical consideration when preparing a work site for use of the camera assembly of the present invention.

In such cases, a sufficient length of wireline is maintained on a spool or drum at the earth's surface near the upper opening of a wellbore. The distal or leading end of said wireline is connected to a camera device. Said leading end (and any attached tools) are vertically aligned over the upper opening of a wellbore and suspended in place using an arrangement of beneficially positioned sheaves or pulleys. Said wireline and any attached tools can then be conveyed into a wellbore by unspooling said wireline from said spool, manipulated within said wellbore, and then retrieved from said well by re-winding said wireline on said spool.

Generally, such wireline can comprise conductive electric line or “e-line” that permits the transmission of electrical charges and/or data through said line. Alternatively, said wireline can comprise non-conductive “slickline” that does not permit such transmission of data or electrical charges. Both of these types of wireline can be used to convey camera systems in and out of wells, and to obtain visual images of a wellbore environment using said camera systems. However, only electric line can be used to convey electrical charges and data to and from a downhole camera system to the earth's surface; slickline does not have such capability. Fiber optic cables are able to transmit data, however fiber optic lines are not capable of transmitting power to downhole tools.

Certain camera systems conveyed via electric line can send live images or video from a downhole wellbore environment to the surface, where such data can be viewed and stored for subsequent transmission, review, and evaluation. However, such video is typically transmitted at a slower than streaming rate (typically less than five frames per second). Further, such camera systems also require a video buffering mode; when said video buffering mode is activated, live video transmission must cease while acquired data is recorded to onboard memory. Only after such data has been recorded to onboard memory can live video feed to the earth's surface resume.

Data (whether video images or otherwise) recorded to onboard memory may be retrieved by transmitting said data through electric line to surface equipment while a camera system is still deployed downhole within in a well. However, during the transmission of data, conventional camera systems do not permit both data transmission and live viewing of video. Thus, such transmission of data recorded downhole within a wellbore via electric line eliminates the possibility of a live video feed at surface. Without a live video feed, an operator is not able to view a wellbore environment (such as, for example, the position of a downhole camera system), and could overlook key events or information occurring within said well.

Camera systems conveyed via slickline can generally record high quality video or other visual images according to a predetermined schedule. However, said visual images or other data cannot be transmitted to the earth's surface via typical slickline. Accordingly, the visual images or other data is typically recorded in onboard memory in the camera system for subsequent viewing after said camera system has been retrieved from a wellbore and images/data have been downloaded or otherwise extracted from the memory of the camera system.

Slickline deployed camera systems require that a downhole camera be programmed with a predetermined activation and/or deactivation schedule at the earth's surface prior to deployment within a wellbore. As a result, all subsequent wellbore operations must be timed to fit said schedule of the programmed camera system. If said operations fail to progress according to such schedule, a camera system can record video images or other data when the camera system is not property positioned within a wellbore. Even if operations adhere to a preprogrammed schedule, such slickline conveyed camera systems can nonetheless fail to record important information due to improper or mistimed positioning of said camera system within a wellbore. Moreover, such failure is frequently not known until after a camera system has been retrieved from a wellbore and recorded data is extracted and viewed.

Thus, there is a need for a combination live feed and memory camera system providing for a real time surface streaming video feed of visual images recorded downhole within a wellbore, while a memory camera simultaneously records full-motion video data downhole within said wellbore.

### SUMMARY OF THE INVENTION

The present invention comprises a method and apparatus for a combination live feed and memory camera recording system providing for a real time surface feed of video data acquired downhole within a well, as well as simultaneously recording of high quality full-motion video downhole within said wellbore.

In a preferred embodiment, the present invention comprises an electric line deployed, downhole camera system that permits live video transmission of data acquired within a wellbore to surface equipment, while simultaneously recording high-quality video to onboard memory without cessation of said live transmission. The camera assembly of the present invention can be equipped with an onboard power supply, memory, camera sensor, and lens, while being designed to accommodate severe pressure and temperature observed in downhole wellbore environments. Said camera assembly can also comprise transceiver to allow live video and still images to be viewed at the earth's surface while being able to program and command the onboard memory portion of the tool.

The present invention advantageously allows for live feed of visual images at surface during simultaneous recording of high-quality video to onboard memory. As such, the present invention eliminates the risk of wrongful positioning of a downhole camera system by permitting an operator to visually observe a wellbore environment at the earth's surface via real time streaming video such as, for example, during positioning of a camera system within a wellbore downhole. The present invention further allows for re-programming, activation and/or deactivation commands while recording to onboard memory which, in turn, eliminates the risk of alterations in operational schedules to render a pre-programmed tool unable to record desired locations and/or events.

Raw video is processed by camera sensor hardware and sent to a Digital Signal Processing (“DSP”) chip where analog data is measured, filtered and compressed into a digital signal. Said signal is then received by an ARM (Advanced RISC Machine) or similar processor to create two separate files. ARM processors require significantly less power and commands to accomplish that of typical computer processors (CPUs).

A first file created is a 30-frames per second video file which is saved to onboard memory within the camera assembly. A second file is created having a nominal series of frames taken intermittently from the full-motion video; said frames are then packaged and transmitted to surface computers where images can be viewed in real time, or with minimal delay.

A third type of data file may also be created upon an operator's request. Said third data file, which can be extracted from said full-motion video, can comprise a segment of full-motion video (for example, 30 frames per second video or similar quality) of limited duration. Said video segment file may be transmitted to the earth's surface in response to an operator command.

### BRIEF DESCRIPTION OF DRAWINGS/FIGURES

The foregoing summary, as well as any detailed description of the preferred embodiments, is better understood when read in conjunction with the drawings and figures contained herein. For the purpose of illustrating the invention, the drawings and figures show certain preferred embodiments. It is understood, however, that the invention is not limited to the specific methods and devices disclosed in such drawings or figures.

FIG. 1 depicts a side schematic view of a downhole camera assembly of the present invention.

FIG. 2 depicts a schematic flow chart depicting the process of the present invention.

### DETAILED DESCRIPTION OF A PREFERRED EMBODIMENT

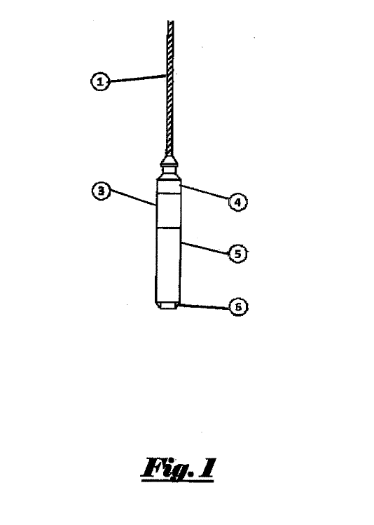

In the following description, like reference numerals will be used to refer to like or corresponding elements among the figures. FIG. 1 depicts a side schematic view of a downhole camera assembly 100 of the present invention. Said camera assembly 100 is beneficially conveyed in and out of a wellbore using electric line 1.

As discussed above, a sufficient length of said electric line is maintained on a spool or drum at the earth's surface near the upper opening of a wellbore. The distal or leading end of said electric line 1 is connected to camera assembly 100 using cable head connector 4. Said leading end (and attached camera assembly 100) are vertically aligned over the upper opening of a wellbore and suspended in place using an arrangement of beneficially positioned sheaves or pulleys.

Camera assembly 100 comprises cable-head connector 4 designed for easy fishing if cable 1 is severed. Camera assembly 100 is further equipped with telemetry sub 3 for transmittal of live feed images and video to surface equipment and receipt of commands and programmability of camera apparatus 5. In a preferred embodiment, camera apparatus 5 houses onboard memory, power, camera processing, lighting and camera sensor in a housing designed to withstand wellbore environments. Said camera apparatus 5 also includes lens and lighting configuration 6.

Camera assembly 100 of the present invention has a number of important benefits. Said camera .assembly 100 can be reprogrammed and controlled from the surface while said camera system is deployed downhole. Conventional slickline-conveyed camera systems cannot be reprogrammed or controlled from the surface.

Camera assembly 100 allows a surface video feed to see/verify what is being recorded downhole. Thus, camera assembly 100 of the present invention permits real time surface viewing by an operator, even while said camera assembly 100 is recording downhole, ensuring capture of desired subject matter. Further, camera assembly 100 can be quickly and efficiently converted to run on slickline simply by changing a cable attachment and adding a battery. Such versatility is a major advantage over conventional camera systems, which require entirely different sets of equipment to alternate between electric line and slickline.

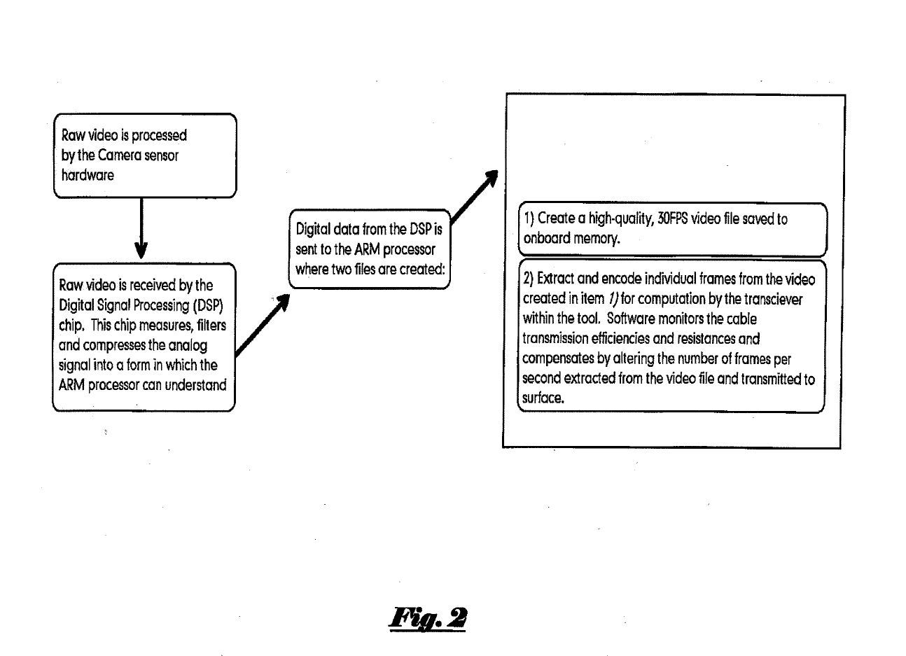

FIG. 2 depicts a flow chart illustrating the method of the present invention. Raw video or other visual image data is acquired by a camera assembly of the present invention and sent to a Digital Signal Processing (DSP) chip, typically in analogue format, where it is measured, filtered and compressed into a digital signal and sent to an ARM-based processor.

Said ARM-based processor concurrently performs two primary actions using the digital data received from said DSP: (1) said digital data received from said DSP is coded into full-motion digital video 30 frames-per-second or similar quality and saved to onboard electronic memory; (2) a separate data file is created having a series of frames taken intermittently from said full-motion video and is transmitted to surface, typically via electric line.

Specifically, said ARM-based processor extracts and encodes individual frames from said full-motion digital video for use by a transceiver within the camera assembly. Software dynamically monitors cable transmission efficiencies and resistances and compensates by altering the number of frames per second extracted from the full-motion video file and transmitted to surface.

Additionally, a third type of data file may also be created. Said third data file, which can be extracted from said full-motion video, can comprise a smaller segment of full-motion video (for example, 30 frames per second video or similar quality) of limited duration. Said video segment file, which is necessarily shorter in duration that said full motion video that is stored to onboard memory, may be transmitted to the earth's surface in response to an operator command.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

We claim:

1. A method for obtaining and transmitting images from a downhole wellbore environment, the method comprising the steps of:
(a) providing a camera apparatus, the camera apparatus including a video camera, an onboard memory, a digital signal processor (DSP), an advanced RISC machine- (ARM-) based processor; a remote surface command processor, and a power supply configured to supply power to the camera apparatus and all of its component parts;
(b) providing a downhole telemetry device in data communication with the camera apparatus;
(c) suspending the camera apparatus and the telemetry device from a length of downhole electric line (e-line);
(d) lowering the camera apparatus and the telemetry device into a wellbore;
(e) exchanging data between the surface and the camera apparatus via the e-line and the telemetry device;
(f) simultaneous with step (e), powering the camera apparatus and telemetry device via the e-line;
(g) responsive to surface commands sent to the remote surface command processor via the e-line, causing the camera assembly to acquire video information regarding the surrounding wellbore;
(h) in real time, causing the DSP to process the video information acquired in step (g) into a digital video signal, and to send the digital video signal to the ARM-based processor;
(i) still in real time, causing the ARM-based processor (1) to store the digital video signal in the onboard memory, and (2) to transmit, responsive to surface commands sent via the telemetry device and the e-line, a lower frame-rate version of the digital video signal to the surface.

2. The method of claim 1, in which step (h) further includes the substep of causing the DSP to process the video information acquired in step (g) by performing at least one action on the video information selected from the group consisting of (1) measuring, (2) filtering and (3) compressing.

3. The method of claim 1 or 2 in which step (h) further includes the substep of causing the DSP to process the video information into a digital video signal having a frame rate of at least 30 frames per second.

4. The method of any of claims 1-3, in which the video information in step (g) is in an analog format.

5. The method of any of claims 1-4, in which step (i) further includes the substep of varying, responsive to surface commands sent via the telemetry device and the e-line, the frame rate of the lower frame-rate digital video signal transmitted to the surface.

6. The method of any of claims 1-5, further comprising:
(j) causing the ARM-based processor to selectively transmit, responsive to surface commands sent via the telemetry device and the e-line, a predetermined length of the digital video signal.

7. The method of claim 6, in which the predetermined length of the digital video signal is one frame.
